(19) United States
(12) Patent Application Publication
(10) Pub. No.: US 2024/0254016 A1
(43) Pub. Date: Aug. 1, 2024

(54) SYSTEM CONFIGURATION FOR SEAWATER REVERSE OSMOSIS (SWRO) FOR HIGHER RECOVERY OPERATIONS AND LOWER FOULING PROPENSITY

(71) Applicant: ACWA POWER Company, Riyadh (SA)

(72) Inventors: Thomas ALTMANN, Dubai (AE); Ratul DAS, Thuwal (SA)

(73) Assignee: ACWA POWER Company, Riyadh (SA)

(21) Appl. No.: 18/424,653

(22) Filed: Jan. 26, 2024

Related U.S. Application Data
(60) Provisional application No. 63/441,586, filed on Jan. 27, 2023.

(51) Int. Cl. C02F 1/44; C02F 101/20; C02F 103/08

(52) U.S. Cl. CPC C02F 1/441; C02F 2101/203; C02F 2103/08

(57) ABSTRACT

An apparatus and a method for seawater reverse osmosis controls mixing units to perform a first stage treatment of a liquid stream by adding a first set of chemical compounds to obtain a first liquid stream. The apparatus controls an ultrafiltration unit to perform a first stage purification by removing a first set of impurities to obtain a second liquid stream. The apparatus also controls a reverse osmosis (RO) membrane unit to remove a second set of chemical compounds by passing the second liquid stream through the RO membrane. The RO membrane outputs at least one of an RO brine stream and an RO permeate stream. The apparatus also controls an ion exchange unit to remove a third set of chemical compounds from the RO permeate stream to obtain a filtered liquid stream, and the apparatus stores the filtered liquid stream.

### CROSS-REFERENCE TO RELATED APPLICATIONS

This application claims priority to U.S. Provisional Patent Application Ser. No. 63/441,586, filed Jan. 27, 2023, and entitled “SYSTEM CONFIGURATION FOR SEAWATER REVERSE OSMOSIS (SWRO) FOR HIGHER RECOVERY OPERATIONS AND LOWER FOULING PROPENSITY”, the disclosure of which is incorporated herein by reference.

### TECHNICAL FIELD

This disclosure relates to the field of liquid-treatment apparatus and methods. More specifically, the present disclosure relates to seawater reverse osmosis (SWRO or seawater RO) apparatus for higher recovery and lower fouling propensity.

### BACKGROUND

In recent years, a global issue of water shortage is increasing. Approximately 97% of water on our planet is seawater and remaining freshwater, there is lack of freshwater for human use. Moreover, freshwater shortage is a major problem owing to extreme weather conditions, desertification, and water pollution. As freshwater nourishes and sustains life, incessant population growth demands a greater supply of the freshwater. While advent and continuous improvement of freshwater generation technologies have existed, the rate of production of the freshwater has gradually decreased over the last few years. Accordingly, lower cost and energy-efficient seawater desalination process is becoming a critical agenda among desalination investors, developers, and off-takers in water-stressed regions.

Among all, seawater reverse osmosis is considered the most efficient freshwater generation method, but the current system and technology are already approaching theoretical limit of specific energy consumption (SEC) for this process which is around 1.5 Kilowatt-hour per cubic meters (kWh/m3). One of major sources of operation cost for the “SWRO” is membrane replacement cost. Membrane replacement is certainly unavoidable due to, for instance, biofouling and mineral scaling. However, the frequency of membrane replacement can be further minimized by optimizing apparatus design.

### SUMMARY

In comparison with the traditional techniques the present disclosure provides an improved design of a seawater RO desalination apparatus for seawater reverse osmosis process to produce freshwater that allows a single-pass design with higher recovery operation and reduced fouling on membranes thereby reducing specific energy consumption (SEC) in the process.

It is an objective of the disclosure to provide an improved design of the seawater RO desalination system to produce freshwater, which may be configured to reduce SEC of the seawater desalination process. The present disclosure may provide the improved design of the seawater RO desalination apparatus to produce freshwater that may be configured to reduce salt content and high fouling propensity of the seawater. Further, the disclosure may provide the improved design of the seawater RO desalination apparatus which may be useful for freshwater production through seawater desalination in Middle East and North Africa (MENA) region.

In one aspect, a seawater reverse osmosis apparatus for higher recovery and lower fouling propensity is provided. The apparatus may include one or more processors. The processor may be configured to control one or more mixing units to perform a first stage treatment of liquid stream by adding a first set of chemical compounds in the liquid stream. The first set of chemical compounds may be added in the liquid stream to obtain a first liquid stream. The processor may be further configured to control an ultrafiltration unit to perform a first stage purification of the first liquid stream by removing a first set of impurities from the first liquid stream. The first set of impurities may be removed from the first liquid stream to obtain a second liquid stream. The processor may be further configured to control a reverse osmosis (RO) membrane unit to remove a second set of chemical compounds by passing the second liquid stream through a RO membrane to output at least one of a RO brine stream, and a RO permeate stream. The processor may be further configured to control an ion exchange unit to remove a third set of chemical compounds from the RO permeate stream. The third set of chemical compounds may be removed from the RO permeate stream to obtain a filtered liquid stream. Further, the processor may be configured to store the filtered liquid stream.

In one embodiment, the first set of chemical compounds further includes at least one of carbon dioxide (CO2), chlorine dioxide (ClO2) and ferric chloride (FeCl3).

In another embodiment, the first set of impurities include at least one of suspended solids, colloidal particulates, or other organic contaminants.

In another embodiment, the second set of chemical compounds further includes at least one of salts, minerals, cations, or anions.

In yet another embodiment, the third set of chemical compounds further includes boron.

In one embodiment, the processor may be configured to control the one or more mixing units to modify a Potential of Hydrogen (pH) value based on the addition of the first set of chemical compounds. A pH value of the first liquid stream may be lesser than a pH value of the liquid stream. Further, the processor may be configured to control the one or more mixing units to remove a second set of impurities from the liquid stream based on the addition of the first set of chemical compounds. The processor may be further configured to control the one or more mixing units to agglomerate the first set of impurities of the liquid stream based on the addition of the first set of chemical compounds.

In another embodiment, the second set of impurities further includes at least one of microorganisms, or biological contaminants.

In another embodiment, the apparatus may further include a nanofiltration (NF) membrane unit. The processor may be configured to control the NF membrane unit to perform a second stage purification of the second liquid stream to output at least one of a NF brine stream, and a NF permeate stream. The processor may be further configured to transfer the NF permeate stream to the RO membrane unit to obtain the filtered liquid stream.

In yet another embodiment, the processor may be further configured to control the NF membrane unit to modify a pressure value of the second liquid stream to obtain the NF permeate stream, a first pressure value of the second liquid stream may be greater than a second pressure value of the NF permeate stream. The processor may be further configured to control the NF membrane unit to inhibit divalent ions of the second liquid stream to obtain the NF brine stream. Further, the processor may be configured to control the NF membrane unit to permit the NF permeate stream to pass through the NF membrane unit. The NF permeate stream may correspond to a monovalent rich stream.

In one embodiment, the apparatus further includes a brine processing unit. The processor may be further configured to control the brine processing unit to process the NF brine stream to extract a fourth set of chemical compounds.

In other embodiment, the fourth set of chemical compounds further includes at least one of magnesium, calcium, sulphate or bromate.

In another embodiment, the RO membrane may further include at least one of a spiral wound RO membrane, or a hollow fiber RO membrane.

In other aspect, seawater reverse osmosis (SWRO) method for higher recovery and lower fouling propensity is provided. The method may include controlling one or more mixing units to perform a first stage treatment of liquid stream by adding a first set of chemical compounds to the liquid stream. The first set of chemical compounds may be added in the liquid stream to obtain a first liquid stream. The method may further include controlling an ultrafiltration unit to perform a first stage purification of the first liquid stream by removing a first set of impurities from the first liquid stream. The first set of impurities may be removed from the first liquid stream to obtain a second liquid stream. The method may further include controlling a reverse osmosis (RO) membrane unit to remove a second set of chemical compounds by passing the second liquid stream through a RO membrane to output at least one of a RO brine stream, and a RO permeate stream. The method may further include controlling an ion exchange unit to remove a third set of chemical compounds from the RO permeate stream. The third set of chemical compounds may be removed from the RO permeate stream to obtain a filtered liquid stream. Further, the method may include storing the filtered liquid stream.

In one method embodiment, the first set of chemical compounds further includes at least one of carbon dioxide (CO2), chlorine dioxide (ClO2) and ferric chloride (FeCl3).

In other method embodiment, the method may include controlling the one or more mixing units to modify a Potential of Hydrogen (pH) value based on the addition of the first set of chemical compounds, a pH value of the first liquid stream may be less than a pH value of the liquid stream. The method may further include controlling the one or more mixing units to remove a second set of impurities from the liquid stream based on the addition of the first set of chemical compounds. Further, the method may include controlling the one or more mixing units to agglomerate the first set of impurities of the liquid stream based on the addition of the first set of chemical compounds.

In another method embodiment, the method may include controlling a nanofiltration (NF) membrane unit to perform a second stage purification of the second liquid stream to output at least one of a NF brine stream, and a NF permeate stream. The method may further include transferring the NF permeate stream to the RO membrane unit to obtain the filtered liquid stream.

In one method embodiment, the method may include controlling the NF membrane unit to modify a pressure value of the second liquid stream to obtain the NF permeate stream, a first pressure value of the second liquid stream may be greater than a second pressure value of NF permeate stream. The method may further include controlling the NF membrane unit to inhibit divalent ions of the second liquid stream to obtain the NF brine stream. Further, the method may include controlling the NF membrane unit to permit the NF permeate stream to pass through the NF membrane unit. The NF permeate stream may correspond to a monovalent rich stream.

In another method embodiment, further include passing the NF brine stream, through a brine processing unit, to extract a fourth set of chemical compounds.

In yet another aspect, a non-transitory computer-readable storage medium carrying one or more sequences of one or more instructions which, when executed by at least one processor, cause an apparatus to perform operations comprising, controlling one or more mixing units to perform a first stage treatment of liquid stream by adding a first set of chemical compounds to the liquid stream. The first set of chemical compounds are added in the liquid stream to obtain a first liquid stream. The operations may further include controlling an ultrafiltration unit to perform a first stage purification of the first liquid stream by removing a first set of impurities from the first liquid stream. The first set of impurities may be removed from the first liquid stream to obtain a second liquid stream. The operations may further include controlling a nanofiltration membrane unit to perform a second stage purification of the second liquid stream by at least one of modifying a pressure value of the second liquid stream, inhibiting divalent ions of the second liquid stream, and permitting a monovalent rich stream to pass through the NF membrane unit. The second liquid stream is passed through the NF membrane unit to output at least one of a NF brine stream, and a NF permeate stream. The operations may further include controlling a reverse osmosis (RO) membrane unit to remove a second set of chemical compounds by passing the NF permeate stream through a RO membrane to output at least one of a RO brine stream, and a RO permeate stream.

The operations may further include controlling an ion exchange unit to remove a third set of chemical compounds from the RO permeate stream. The third set of chemical compounds may be removed from the RO permeate stream to obtain a filtered liquid stream. Further, the operations may include storing the filtered liquid stream.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 is a diagram that illustrates a network environment in which an apparatus for seawater reverse osmosis is implemented, in accordance with an embodiment of the disclosure;

FIG. 2 illustrates a block diagram of the apparatus of FIG. 1, in accordance with an embodiment of the disclosure;

FIG. 3 is a diagram that illustrates exemplary operations for seawater reverse osmosis using a spiral wound RO membrane, in accordance with an embodiment of the disclosure;

FIG. 4 is a diagram that illustrates an exemplary block diagram of the apparatus for seawater reverse osmosis using the spiral wound RO membrane and a nanofiltration unit, in accordance with an embodiment of the disclosure;

FIG. 5 is a diagram that illustrates an exemplary block diagram of the apparatus for seawater reverse osmosis using a hollow fiber RO membrane, in accordance with an embodiment of the disclosure;

FIG. 6 is a block diagram that illustrates an exemplary block diagram of the apparatus for seawater reverse osmosis using the hollow fiber RO membrane and the nanofiltration unit, in accordance with an embodiment of the disclosure; and

FIG. 7 is a flowchart that illustrates an exemplary method for seawater reverse osmosis, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

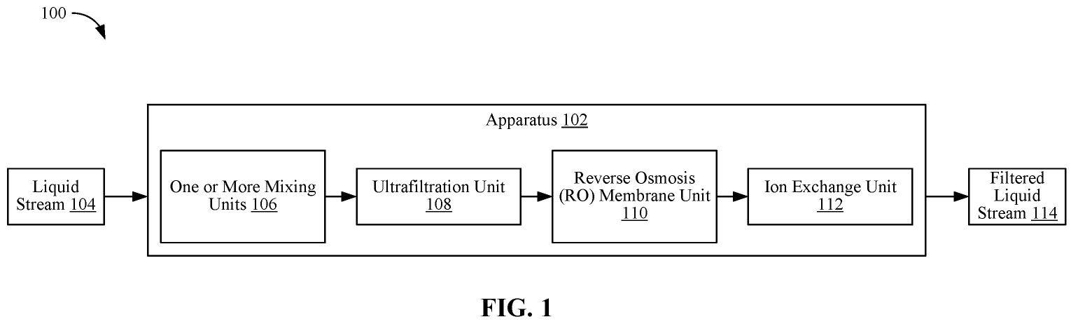

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 7, a brief description concerning the various components of the present disclosure will now be briefly discussed. Reference will be made to the figures showing various embodiments of an apparatus for seawater reverse osmosis.

FIG. 1 illustrates a network environment in which an apparatus for seawater reverse osmosis is implemented, in accordance with an embodiment of the disclosure. With reference to FIG. 1, there is shown a network environment 100. The network environment 100 may include an apparatus 102 which may be used for seawater reverse osmosis to produce freshwater. The network environment 100 may further include a liquid stream 104 and a filtered liquid stream 114. The apparatus 102 may include a one or more mixing units 106, an ultrafiltration unit 108, a reverse osmosis (RO) membrane unit 110 and an ion exchange unit 112.

In an embodiment, the apparatus 102 may be designed to perform the operation of the seawater reverse osmosis (SWRO) to produce freshwater. The seawater reverse osmosis technique may employ a use of semi-permeable membranes that allows a solvent to pass through, while restricting solutes (such as impurities), leading to separation of salt and the freshwater. The apparatus 102 may be configured to control the one or more mixing units 106 to receive the liquid stream 104. The liquid stream 104 for example, but is not limited to, the seawater or saltwater. The one or more mixing units 106 may receive the liquid stream 104 from various sources. Examples of such sources may include, but are not limited to, a storage tank, an open inlet, an open seawater intake pipe, and a beach well. In an example, a Total Dissolved Solids (TDS) value for the liquid stream 104 may range from 37,000 to 50,000 milligrams per liter (mg/l). Further, a Potential of Hydrogen (pH) value of the liquid stream 104 may lie within a range of 7 to 8.6. Additionally, the liquid stream 104 may have a high salt content, thereby making the liquid stream 104 unsafe for human use.

Conventionally, a seawater desalination technique may be employed to obtain the filtered liquid stream by removing excessive salt content from the liquid stream 104. The filtered liquid stream 114 may be, but is not limited to, the freshwater. The pH value of the filtered liquid stream 114 may lie within the range of 5 to 7.2, making the filtered liquid stream 114 fit for human consumption. Examples of various methods of treatment of the seawater desalination may include but are not limited to evaporation of liquid stream 104, and a membrane separation method based on differential and selective permeation ability of the membrane. In an example, the membrane separation method may correspond to a reverse osmosis (RO) process. The reverse osmosis may refer to a technique by which the freshwater (such as, the filtered liquid stream 114) is extracted by application of higher than osmotic pressure of the seawater (such as, the liquid stream 104) with a semipermeable membrane interposed in between.

In an embodiment, the apparatus 102 may be configured to perform the SWRO to obtain the filtered liquid stream 114 by reducing a pH value of the liquid stream 104 and removing impurities from the liquid stream 104. Such a reduction of the pH value of the liquid stream 104 and removal of the impurities from the liquid stream 104 may reduce biofouling on the membrane surface (such as, the semi-permeable membranes) in the downstream RO process, thereby reducing an operational cost of the apparatus 102. Further, the RO process may reduce energy consumption by utilizing half of the energy required in electroosmotic process and one-fourth of the energy of the distillation method, thereby making the apparatus 102 cost effective.

In one embodiment, the apparatus 102 may be, but is not limited to, an industrial RO plant, a domestic RO plant, a seawater desalination plant, a portable RO plant, and a wastewater reclamation RO plant.

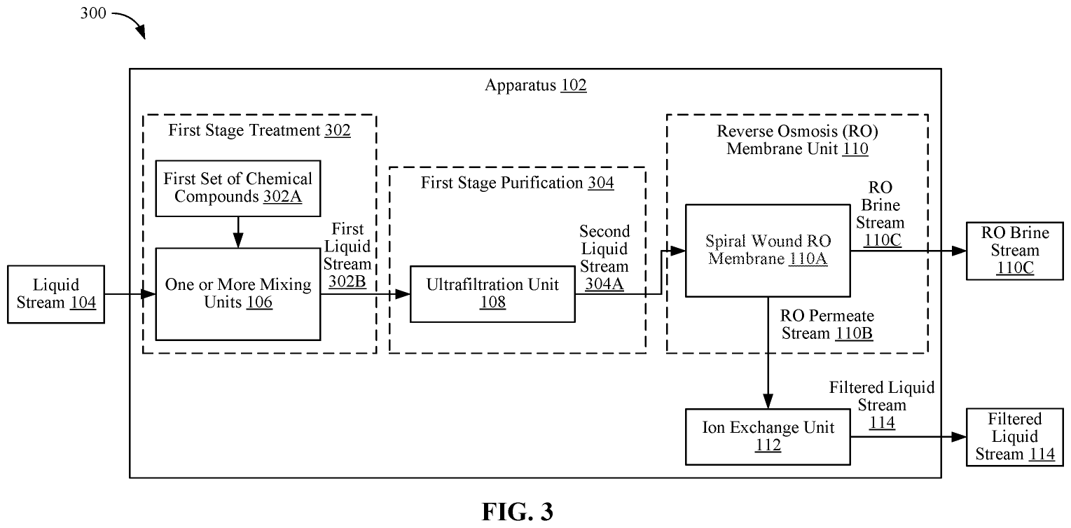

In an embodiment, the apparatus 102 may control the one or more mixing units 106 to perform a first stage treatment of the liquid stream 104. The apparatus 102 may be configured to control the one or more mixing units 106 to receive the liquid stream 104 (such as, the seawater, or saltwater) and add a first set of chemical compounds to the received liquid stream 104. The first stage treatment of the liquid stream 104 may correspond to addition of the first set of chemical compounds to the liquid stream 104 to obtain a first liquid stream. Such chemical treatment of the liquid stream 104 may reduce the pH value of the liquid stream 104 and may further eliminate the microorganisms and biological contaminants that may be present in liquid stream 104 to produce the first liquid stream. Further details about the first stage treatment are provided in FIG. 3.

In one embodiment, the apparatus 102 may control the ultrafiltration unit 108 to perform a first stage purification of the first liquid stream by removing a first set of impurities from the first liquid stream to obtain the second liquid stream. The ultrafiltration unit 108 may use a semi-permeable membrane to separate particles and solutes from the first liquid stream. The ultrafiltration unit 108 may operate on a principle of sieving, allowing water and small molecules to pass through while retaining larger particles. The ultrafiltration unit 108 may include at least one membrane. Examples of the at least one membrane may include, but are not limited to, a hallow fiber ultrafiltration, a spiral-wound ultrafiltration, a tabular ultrafiltration and a ceramic ultrafiltration. Further details about the first stage purifications are provided in FIG. 3.

The apparatus 102 may be configured to control the RO membrane unit 110 to remove a second set of chemical compounds by passing the second liquid stream through a RO membrane to output at least two liquid streams. The at least two liquid steams may include, but not limited to, a RO brine stream and a RO permeate stream. The RO brine stream may correspond to a concentrated by-product that may be rich in salts and impurities generated during the reverse osmosis desalination process. Further, the RO permeate stream may correspond to a low TDS stream. The RO permeate stream may include significantly reduced levels of salts, minerals and other impurities. The RO membrane unit 110 may include, but not limited to, at least one of a spiral wound RO membrane, a hollow fiber RO membrane. Further details about the RO membrane unit 110 are provided in FIG. 3.

In one embodiment, the second set of chemical compounds that may be removed from the second liquid stream may be, but are not limited to, salts, minerals, cations, or anions.

In an exemplary embodiment, the RO brine stream may be further processed to produce for example, sodium chloride or may be discharged to the sea.

In an embodiment, the apparatus 102 may be configured to control the ion exchange unit 112 to receive the RO permeate stream from the RO membrane unit 110 to obtain the filtered liquid stream 114. The ion exchange unit 112 may employ ion exchange resins to remove dissolved ions from the RO permeate stream received from the RO membrane unit 110. The resins may selectively exchange certain ions that may be present in the RO permeate stream with the ions of the same charge that may be immobilized on the resin. For example, the ion exchange unit 112 may exchange calcium and magnesium ions with the sodium ions in the RO permeate stream. Further details of the ion exchange unit 112 are provided in FIG. 3.

In operation, the apparatus 102 may control the one or more mixing units 106 to receive the liquid stream 104 (such as, the seawater or saltwater) from an input feed for example, but not limited to, a storage tank, an open inlet, an open seawater intake pipe, and a beach well. Upon receiving the liquid stream 104, the apparatus 102 may control the one or more mixing units 106 to perform the first stage treatment. In the first stage treatment, the first set of chemical compounds may be added to the liquid stream 104 to obtain the first liquid stream. The first set of chemical compounds may include, but are not limited to, carbon dioxide (CO₂), chlorine dioxide (ClO₂) and ferric chloride (FeCl₃). The apparatus 102 may be further configured to obtain the first liquid stream from the one or more mixing units 106.

Thereafter, the apparatus 102 may be configured to control the ultrafiltration unit 108 to perform the first stage purification. The ultrafiltration unit 108 may receive the first liquid stream from the one or more mixing units 106. Further, the first stage purification may be performed by removing the first set of impurities from the first liquid stream. The ultrafiltration unit 108 may remove the first set of impurities to obtain the second liquid stream. The first set of impurities may include suspended solids, colloidal particulates or other organic contaminants. The other organic contaminants may further include, for example, magnesium, calcium, strontium, chloride, sulphate and the like.

The apparatus 102 may be further configured to control the RO membrane unit 110 to pass the second liquid stream through the RO membrane to output at least one of the RO brine stream and the RO permeate stream. The RO membrane unit 110 may receive the second liquid stream from the ultrafiltration unit 108. The RO membrane unit may remove the second set of chemical compounds from the received second liquid stream by passing the second liquid stream through the RO membrane. The RO membrane unit 110 may include RO membranes for example, but not limited to, at least one of a spiral wound RO membrane, or a hollow fiber RO membrane. Further, the apparatus 102 may control the RO membrane unit 110 to pass the RO permeate stream to the ion exchange unit 112.

Thereafter, the apparatus 102 may be further configured to control the ion exchange unit 112. The ion exchange unit 112 may receive the RO permeate stream from the RO membrane unit 110. The apparatus 102 may control the ion exchange unit 112 to remove the third set of chemical compounds from the RO permeate stream. The third set of chemical compounds may include, for example, but not limited to boron. Upon removal of the third chemical compounds from the RO permeate stream, the filtered liquid stream 114 may be obtained. The filtered liquid stream 114 may be, for example, fresh water. Examples of the ion exchange unit 112 that may be used in the apparatus 102 may include, but not limited to, a cation exchange unit, or an anion exchange unit.

In an embodiment, the apparatus 102 may be configured to store the filtered liquid stream 114. The filtered liquid stream 114 stream obtained from the apparatus 102 may be used for human consumption, agricultural irrigation, industrial processes, power generation, pharmaceutical production, commercial and residential use and the like.

In an example, a fouling of the membrane (such as the semi-permeable membrane or the RO membrane) in seawater reverse osmosis plants occurs when impurities accumulate on the membrane surface, thereby reducing water flow and efficiency. Such accumulation of impurities may include a build-up of for example, but not limited to salts, organic matter, and microorganisms. Such a build-up of impurities may lead to a decrease in desalination performance. To overcome the problems associated with the membrane fouling in the seawater reverse osmosis plants, the apparatus 102 may employ pre-treatment processes mentioned above (such as the addition of the first set of chemical compounds, and removal of the first of set impurities). Such chemical treatment and purification of the liquid stream 104 may significantly reduce a frequency of fouling occurrences which may further reduce the operational cost of the seawater reverse osmosis plant.

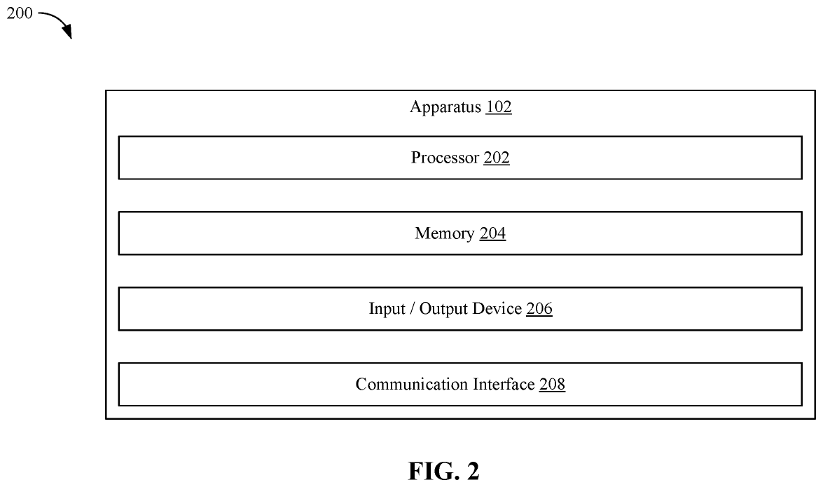

FIG. 2 illustrates a block diagram 200 of the apparatus of FIG. 1, in accordance with an embodiment of the disclosure. FIG. 2 is explained in conjunction with FIG. 1. In FIG. 2, there is shown the block diagram 200 of the apparatus 102. The apparatus 102 may include at least one processor (referred to as a processor 202, hereinafter), at least one non-transitory memory (referred to as a memory 204, hereinafter), an input/output (I/O) interface 206, and a communication interface 208. The processor 202 may be connected to the memory 204, the I/O interface 206, and the communication interface 208 through one or more wired or wireless connections. Although in FIG. 2, it is shown that the apparatus 102 includes the processor 202, the memory 204, the I/O interface 206, and the communication interface 208 however, the disclosure may not be so limiting and the apparatus 102 may include fewer or more components to perform the same or other functions of the apparatus 102.

The processor 202 of the apparatus 102 may be configured to perform one or more operations associated with the seawater reverse osmosis. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the apparatus 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The communication network may be accessed using the communication interface 208 of the apparatus 102. The communication interface 208 may provide an interface for accessing various features and data stored in the apparatus 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the apparatus 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein. In an embodiment, memory may be configured to store the first set of data structures 118, the second set of data structures 120, and the third set of data structures 122.

In some example embodiments, the I/O interface 206 may communicate with the apparatus 102 and display the input and/or output of the apparatus 102. As such, the I/O interface 206 may include a display and, in some embodiments, may also include a keyboard, a mouse, a touch screen, touch areas, soft keys, or other input/output mechanisms. In one embodiment, the apparatus 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry including the processor 202 may be configured to control one or more functions of one or more I/O interface 206 elements through computer program instructions (for example, software and/or firmware) stored on a memory 204 accessible to the processor 202.

The communication interface 208 may include the input interface and output interface for supporting communications to and from the apparatus 102 or any other component with which the apparatus 102 may communicate. The communication interface 208 may be any means such as a device or circuitry embodied in either hardware or a combination of hardware and software that is configured to receive and/or transmit data to/from a communications device in communication with the apparatus 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms.

FIG. 3 illustrates exemplary operations for seawater reverse osmosis using a spiral wound RO membrane, in accordance with an embodiment of the disclosure. FIG. 3 is explained in conjunction with FIG. 1 and FIG. 2. In FIG. 3 there is shown a block diagram 300 of the apparatus 102 for seawater reverse osmosis. The apparatus 102 may include the first stage treatment 302, the first stage purification 304, the RO membrane unit 110, and the ion exchange unit 112. The first stage treatment 302 further includes the one or more mixing units 106, and a first set of chemical compounds 302A. The first stage purification 304 includes the ultrafiltration unit 108. The RO membrane unit 110 includes spiral wound RO membrane 110A.

In one embodiment, the processor 202 of the apparatus 102 may be configured to control the one or more mixing units 106 to perform the first stage treatment 302 of the liquid stream 104. In the first stage treatment 302, the first set of chemical compounds 302A may be added to the liquid stream 104 that may be present in the one or more mixing units 106. The first set of chemical compounds may include, but are not limited to, a carbon dioxide (CO₂), a chlorine dioxide (ClO₂) and a ferric chloride (FeCl₃).

In an exemplary embodiment, the carbon dioxide may be added to the liquid stream 104 to modify a pH value of the liquid stream 104 present in the one or more mixing units 106. In an example, the pH value of the liquid stream may lie between a range of 7 to 8.6. In such an example, the carbon dioxide may be added to the one or more mixing units 106, thereby reducing the pH value of the liquid stream 104. In an embodiment, a pH value of the first liquid stream 302B may be less than the pH value of the liquid stream 104. For example, the pH value of a first liquid stream 302B may lie between a range of 5 to 7. In an example, the carbon dioxide may reduce the pH of liquid stream 104 through carbonation. Once the carbon dioxide may be dissolved in the liquid stream 104, it may form carbonic acid. Carbonic acid may be a weak acid that may further dissociate to release hydrogen ions that may lead to decrease in pH of the liquid stream 104. This reduction of the pH of the liquid stream 104 may further reduce the scaling potential and may allow a higher recovery operation. This may further improve coagulation and disinfection efficiency and make antiscalant dosing obsolete.

In another exemplary embodiment, the apparatus 102 may be configured to control the one or more mixing units 106 to remove the second set of impurities from the liquid stream 104 based on the addition of the first set of chemical compounds 302A. In an example, when the pH value of the liquid stream 104 may have been reduced (by addition of the carbon dioxide) to an acceptable range, the apparatus 102 may be configured to control the one or more mixing units 106 to add the chlorine dioxide to the liquid stream 104 present in the one or more mixing units 106. The addition of the chlorine dioxide may lead to eliminating the second set of impurities present in the liquid stream 104. Example of the second set of impurities may include, but not limited to, microorganisms and biological contaminants. Such impurities may cause biofouling on the membranes, thus, to eliminate the microorganisms and the biological contaminates, the chlorine dioxide may be added to the liquid stream 104. The chlorine dioxide may be a powerful oxidizing agent. It may react with various cellular components, including proteins and enzymes, disrupting their structure and function. The oxidative stress may damage the microorganisms resulting in the elimination of the microorganisms.

In another exemplary embodiment, the ferric chloride (FeCl₃) may be added to the liquid stream 104 present in the one or more mixing units 106. The ferric chloride may agglomerate colloidal particles that may be present in the liquid stream 104. The ferric chloride may be used as a coagulant in seawater reverse osmosis apparatus. Upon adding the ferric chloride in the liquid stream 104, it may cause hydrolysis, forming hydroxide flocs that may agglomerate and trap a first set of impurities. Examples of the first set of impurities may include, but are not limited to, suspended solids, colloidal particulates, or other organic contaminants. In an example, the ferric chloride added to the liquid stream 104 may form ferric hydroxide and hydrochloric acid. The ferric chloride formed during hydrolysis may further react to form larger flocs. These flocs may contain the adsorbed first set of impurities. The flocs created by the ferric chloride may agglomerate and may be removed by using ultrafiltration unit 108.

In one embodiment, the apparatus 102 may be configured to control the ultrafiltration unit 108 to perform the first stage purification 304 of the first liquid stream 302B. In the first stage purification 304, the apparatus 102 may be configured to control an ultrafiltration unit 108 to receive the first liquid stream 302B and remove the first set of impurities from the first liquid stream 302B.

In an exemplary embodiment, the apparatus 102 may control the ultrafiltration unit 108 to remove the first set of impurities present in the first liquid stream 302B to obtain second liquid stream 304A. Once the first set of impurities may be agglomerated using the first set of chemical compounds 302A in the one or more mixing units 106, the ultrafiltration unit 108 may remove the first set of impurities. The first set of impurities may be removed to eliminate the membrane fouling in downstream processes such as RO membrane unit.

In an exemplary embodiment, the ultrafiltration unit 108 may be a ceramic ultrafiltration unit that may be used to remove the first set of impurities from the first liquid stream 302B to obtain the second liquid stream 304A. The ceramic ultrafiltration unit may involve using the membranes to separate agglomerated particles, allowing only smaller molecules to pass through. The ceramic ultrafiltration unit may be a compact and robust technology without any membrane replacement that may increase overall RO plant availability and may insure full production during all seawater conditions. The ceramic ultrafiltration unit may be coupled with the one or more mixing units 106. The ceramic ultrafiltration unit may be made of material such as, but not limited to, stainless steel, aluminum, cast iron, titanium.

In one embodiment, the filtration of the first liquid stream 302B in one or more mixing units 106 by using the first set of chemical compounds 302A, combined with the ultrafiltration unit 108 may reduce the membrane fouling which may further lead to reduction in chemical cleanings, membrane replacements and energy consumption, thereby reducing the operational costs.

In an embodiment, the RO membrane unit 110 may receive the second liquid stream 304A produced by the ultrafiltration unit 108. The apparatus 102 may be configured to control the RO membrane unit 110 to remove a second set of chemical compounds by passing the second liquid stream 304A through a RO membrane to output at least one of a RO brine stream 110C, and a RO permeate stream 110B. The second set of chemical compounds may include, but are not limited to, salts, minerals, cations, anions. In an exemplary embodiment, the RO brine stream 110C produced by the RO membrane unit may be further processed to produce for example, sodium chloride. In another exemplary embodiment, the RO brine stream 110C may be discharged to the sea.

In an exemplary embodiment, the RO membrane unit 110 may include RO membrane that may be, but not limited to, a spiral wound RO membrane 110A. In an example, the spiral wound RO membrane 110A may correspond to an 8″ spiral wound RO membrane, which may be used in reverse osmosis processes. The spiral wound RO membrane 110A may selectively allow water molecules to pass through and reject impurities, salts and other contaminants. The spiral wound RO membrane 110A may be further suitable for industrial and commercial water treatment systems, such as, but not limited to, desalination plants. In an exemplary embodiment, the diameter of the spiral wound RO membrane 110A may further be, but not limited to, a 12″ spiral wound RO membrane, a 16″ spiral wound RO membrane.

In an exemplary embodiment, the processor 202 of the apparatus 102 may be configured to control the RO membrane unit 110 to remove the first set of chemical compounds 302A from the received second liquid stream 304A. The first set of chemical compounds 302A may include, but are not limited to the carbon dioxide, the chlorine dioxide and the ferric chloride.

Further, in one embodiment, the RO permeate stream 110B may be received by the ion exchange unit 112. The processor 202 of the apparatus 102 may be configured to control the ion exchange unit 112 to remove a third set of chemical compounds from the RO permeate stream 110B to obtain the filtered liquid stream 114. The third set of chemical compounds may be, but are not limited to, boron. The ion exchange unit 112 may be coupled with the RO membrane unit 110. In an exemplary embodiment, the RO permeate stream may be sent through a specific ion exchange resin bed to remove the boron. The resin bed that may be present in the ion exchange unit 112 may be made from material such as, but are not limited to, gel polymers, zeolites, montmorillonite, clay, and soil humus.

In one embodiment, the processor 202 of the apparatus 102 may be configured to store the filtered liquid stream 114. The stored filtered liquid stream 114 may be used for human consumption or other industrial processes. In an example, the filtered liquid stream 114 may be stored in for example, but not limited to a storage tank.

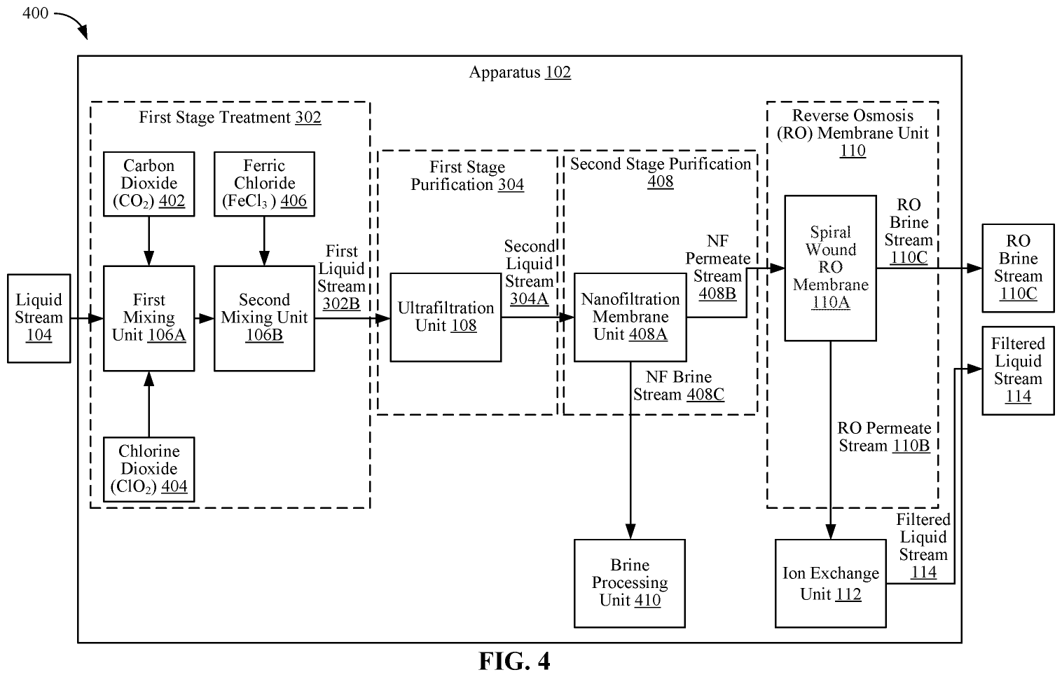

FIG. 4 illustrates an exemplary block diagram of the apparatus for seawater reverse osmosis using the spiral wound RO membrane and a nanofiltration unit, in accordance with an embodiment of the disclosure. FIG. 4 is explained in conjunction with FIG. 1, FIG. 2 and FIG. 3. In FIG. 4 there is shown a block diagram 400 of the apparatus 102 for seawater reverse osmosis. The apparatus 102 may include the first stage treatment 302, the first stage purification 304, a second stage purification 408, the RO membrane unit 110, and the ion exchange unit 112. The first stage treatment 302 further includes a first mixing unit 106A and a second mixing unit 106B, a carbon dioxide unit 402, a chlorine dioxide unit 404, a ferric chloride unit 406. The first stage purification 304 includes the ultrafiltration unit 108. The second stage purification 408 includes a nanofiltration (NF) membrane unit 408A. The RO membrane unit 110 includes the spiral wound RO membrane 110A.

In one embodiment, the apparatus 102 may control the one or more mixing units 106. The one or more mixings units 106 may include for example, the first mixing unit 106A and the second mixing unit 106B. The first mixing unit 106A may receive the liquid stream 104, the carbon dioxide and the chlorine dioxide. The apparatus 102 may control the first mixing unit 106A to add the carbon dioxide to the received liquid stream 104. Further, the apparatus 102 may control the first mixing unit 106A to add the chlorine dioxide to the received liquid stream 104. The processor 202 may be configured to control the first mixing unit 106A to pass the liquid stream 104 to the second mixing unit 106B. The details of the addition of the carbon dioxide (CO2) and the chlorine dioxide (ClO2) are provided in FIG. 3.

In an embodiment, the second mixing unit 106B may receive the liquid stream from the first mixing unit 106A. The apparatus 102 may control the second mixing unit 106B to add ferric chloride (FeCl3) to the liquid stream 104. The details of addition of the ferric chloride (FeCl3) are described in FIG. 3.

In another embodiment, the apparatus 102 may control the ultrafiltration unit 108 to perform the first stage purification 304. The ultrafiltration unit 108 may receive the first liquid stream 302B from the second mixing unit 106B. Further, the ultrafiltration unit 108 may remove the agglomerated first set of impurities from the first liquid stream 302B to obtain second liquid stream 304A. The details of ultrafiltration unit 108 and the first stage purification 304 are described in FIG. 1 and FIG. 3

In one embodiment, the apparatus 102 may further include the NF membrane unit 408A. The NF membrane unit 408A may be coupled with the ultrafiltration unit 108. The apparatus 102 may be configured to control the NF membrane unit 408A to perform the second stage purification 408 of the second liquid stream 304A to output at least one of a NF brine stream 408C, and a NF permeate stream 408B. Further, the apparatus 102 may be configured to transfer the NF permeate stream 408B to the RO membrane unit 110 to obtain the filtered liquid stream 114.

In an embodiment, the NF membrane unit 408A may receive the second liquid stream 304A from the ultrafiltration unit 108. The second liquid stream 304A may include divalent ions. The processor 202 may be configured to control the NF membrane unit 308A to modify a pressure value of the second liquid stream 304A to obtain the NF permeate stream 408B. In an exemplary embodiment, a first pressure value of the second liquid stream 304A may be greater than a second pressure value of the NF permeate stream 408B. The first pressure value of the second liquid stream 304A may lie between, for example, 10-25 bars.

In another embodiment, the second liquid stream 304A may be passed through a nanofiltration membrane in the NF membrane unit 408A. In such a scenario, the second liquid stream 304A may be pressurized to the first pressure value and passed through the NF membrane. The NF membrane corresponds to a semi-permeable membrane with specific characteristics that may selectively allow the passage of certain ions and molecules. In an exemplary embodiment, the NF membrane may inhibit divalent ions, restricting their passage. The divalent ions may be the ions with positive charge of +2. The examples of the divalent ions include, but are not limited to calcium, magnesium, strontium, barium.

In an exemplary embodiment, the nanofiltration process that may be achieved using NF membrane unit 408A may remove divalent ion that may further reduce scaling potential in the downstream RO process. The reduction in the scaling potential may further reduce the membrane fouling, thereby making the apparatus 102 cost effective.

In another exemplary embodiment, the NF membrane unit 408A may remove the first set of chemical compounds 302A from the second liquid stream 304A. The first set of chemical compounds 302A may include, but are not limited to, carbon dioxide (CO₂), chlorine dioxide (ClO₂) and ferric chloride (FeCl₃).

In yet another embodiment, a portion of the second liquid stream 304A may be permitted to pass through the NF membrane unit 408A. The portion that may be passed through the NF membrane unit 408A may be the NF permeate stream 408B. The NF permeate stream 408B corresponds to a monovalent rich stream. The NF membrane unit 308A may selectively allow the monovalent rich stream to pass through while inhibiting divalent ions rich NF brine stream. In an exemplary embodiment, the NF permeate stream 408B may be desalinated water with lower TDS. The lower TDS may allow for a higher recovery operation in the downstream RO process.

In an exemplary embodiment, the portion of the second liquid stream 304A that may contain the restricted divalent ions may be the NF brine stream 408C. The NF brine stream 408C may be concentrated solution that may include divalent ions. In an exemplary embodiment, the divalent ions may be the fourth set of chemical compounds. The fourth set of chemical compounds may include, but are not limited to, magnesium, calcium, sulphate, bromate.

In an exemplary embodiment, the NF brine stream 408C that may be produced in the NF membrane unit 408A may be a concentrated solution that may contain the rejected salts, ions and impurities from the second liquid stream 304A. The NF membrane unit 408A may selectively separate particles and ions based on their size and charge, allowing water molecules to pass thorough while retaining certain ions. The NF brine stream 408C may undergo further treatment in the brine processing unit 410.

In an embodiment, the apparatus 102 may control the brine processing unit 410 to receive the NF brine stream 408C and extract a fourth set of chemical compounds. The brine processing unit 310 may process the NF brine stream 408C to recover resources such as extracting salts and minerals for reuse or commercial purposes.

In an exemplary embodiment, additional carbon dioxide may be added to the NF brine stream 408C to further reduce a pH of the NF brine stream 408C to produce minerals like magnesium, bromate and the like.

In another exemplary embodiment, the brine processing unit 410 may process the NF brine stream 408C to mitigate the impacts of brine disposal on the environment.

In one embodiment, the apparatus 102 may further control the RO membrane unit 110 to receive the NF permeate stream 408B from the NF membrane unit 408A. The NF permeate stream 408B may be further pressurized and received by the RO membrane unit 110. The NF permeate stream 408B may be pressurized to a pressure level of, for example 50-70 bars. The apparatus 102 may be configured to control the RO membrane unit 110 to split the NF permeate stream 408B into at least two streams. The at least two streams may be, but not limited to, the RO brine stream 110C and the RO permeate stream 110B.

In an embodiment, the apparatus 102 may control the RO membrane unit 110 to remove the second set of chemical compounds by passing the NF permeate stream 408B through the RO membrane and control the ion exchange unit 112 to remove the third set of chemical compounds to obtain the filtered liquid stream 114. The details of the RO membrane unit 110 and the ion exchange unit 112 are described in FIG. 1 and FIG. 3

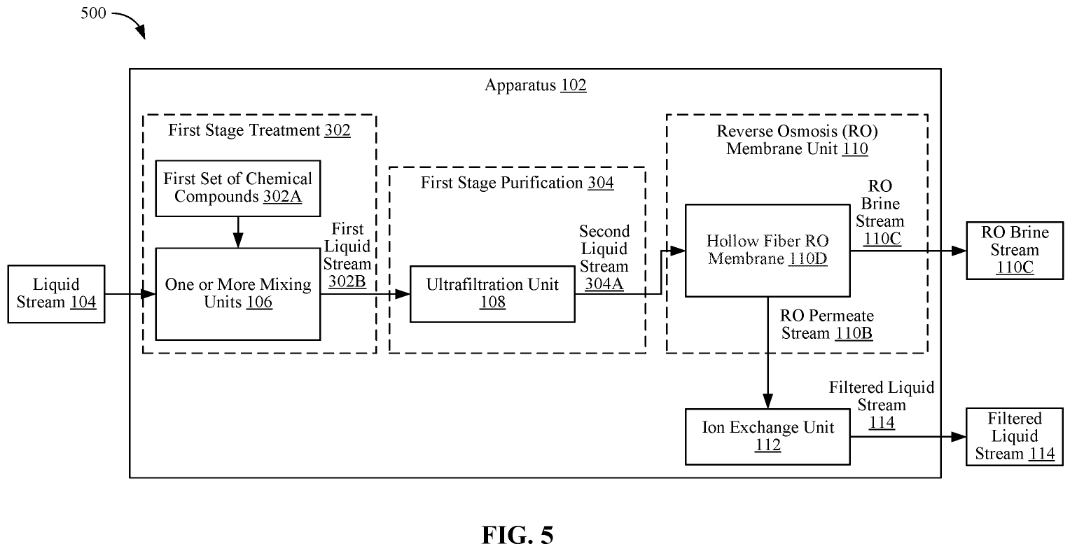

FIG. 5 illustrates an exemplary block diagram of the apparatus for seawater reverse osmosis using a hollow fiber RO membrane, in accordance with an embodiment of the disclosure. FIG. 5 is explained in conjunction with FIGS. 1. 2, 3 and 4. In FIG. 5 there is shown a block diagram 500 of the apparatus 102 for seawater reverse osmosis. The apparatus 102 may include the first stage treatment 302, the first stage purification 304, the RO membrane unit 110, and the ion exchange unit 112. The first stage treatment 302 further includes the one or more mixing units 106, and a first set of chemical compounds 302A. The first stage purification 304 includes the ultrafiltration unit 108. The RO membrane unit 110 includes spiral wound RO membrane 110A.

In one embodiment, the processor 202 of the apparatus 102 may be configured to control the one or more mixing units 106 to perform the first stage treatment 302 of the liquid stream 104. In the first stage treatment 302, the first set of chemical compounds 302A may be added to the liquid stream 104 that may be present in the one or more mixing units 106. The first set of chemical compounds 302A may include, but are not limited to, a carbon dioxide (CO₂), a chlorine dioxide (ClO₂) and a ferric chloride (FeCl₃). The details of the addition of the carbon dioxide (CO₂), the chlorine dioxide (ClO₂) and the ferric chloride (FeCl₃) are described in FIG. 3.

In one embodiment, the apparatus 102 may be configured to control the ultrafiltration unit 108 to perform the first stage purification 304 of the first liquid stream 302B. In the first stage purification 304, the apparatus 102 may be configured to control an ultrafiltration unit 108 to receive the first liquid stream 302B and remove the first set of impurities from the first liquid stream 302B. Examples of the first set of impurities may include, but are not limited to, suspended solids, colloidal particulates, or other organic contaminants. The details of the first stage purification 304 and the ultrafiltration unit are described in FIG. 1 and FIG. 3.

In an embodiment, the RO membrane unit 110 may receive the second liquid stream 304A produced by the ultrafiltration unit 108. The apparatus 102 may be configured to control the RO membrane unit 110 to remove a second set of chemical compounds by passing the second liquid stream 304A through a RO membrane to output at least one of the RO brine stream 110C, and the RO permeate stream 110B. The second set of chemical compounds may include, but are not limited to, salts, minerals, cations, anions. In an exemplary embodiment, the RO brine stream 110C produced by the RO membrane unit 110 may be further processed to produce for example, sodium chloride. In another exemplary embodiment, the RO brine stream 110C may be discharged to the sea.

In an exemplary embodiment, the RO membrane unit 110 may include an RO membrane that may be, but are not limited to, a hollow fiber RO membrane 110D. In an example, the hollow fiber RO membrane 110D may correspond to an 8″ hollow fiber RO membrane that maybe used in reverse osmosis processes. The hollow fiber RO membrane 110D may selectively allow water molecules to pass through and reject impurities, salts and other contaminants. The hollow fiber RO membrane 110D may be further suitable for industrial and commercial water treatment systems, such as, but not limited to, desalination plants.

In one embodiment, the apparatus 102 may use a hollow fiber RO membrane 110D in the RO membrane unit 110. The hollow fiber RO membrane 110D may be for example, 8″ hollow fiber RO membrane. In an exemplary embodiment, the hollow fiber RO membrane 110D may be integrated with the RO membrane unit 110. The hollow fiber RO membrane 110D may be designed to desalinate the liquid stream 104 to produce filtered liquid stream 114. In an exemplary embodiment, the diameter of the hollow fiber RO membrane 110D may further be, but not limited to, a 12″ hollow fiber RO membrane, and a 16″ hollow fiber RO membrane.

In an exemplary embodiment, the hollow fiber RO membrane 110D may have tabular structure, providing a high surface area for efficient filtration. In an embodiment, the hollow fiber RO membrane 110D may selectively allow water molecules to pass through while blocking the contaminants like first set of chemical compounds 302A.

In an exemplary embodiment, the apparatus 102 may be configured to control the RO membrane unit 110 to remove the first set of chemical compounds 302A from the received second liquid stream 108B. The first set of chemical compounds 302A may include the carbon dioxide (CO2), the chlorine dioxide (ClO2) and the ferric chloride (FeCl3).

Further, in one embodiment, the RO permeate stream 110B may be received by the ion exchange unit 112. The apparatus 102 may be configured to control the ion exchange unit 112 to remove a third set of chemical compounds from the RO permeate stream to obtain filtered liquid stream 114. The third set of chemical compounds may be, but are not limited to, boron. In an embodiment, the apparatus 102 may be configured to store the filtered liquid stream 114. The details of the ion exchange unit 112 are provided in FIG. 1 and FIG. 3.

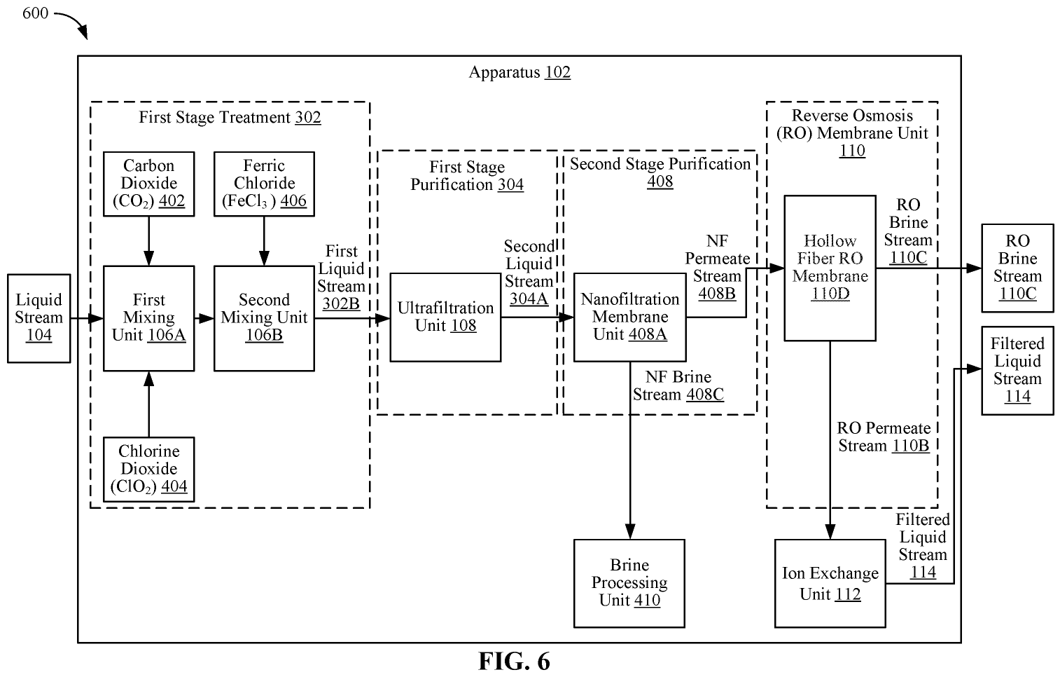

FIG. 6 illustrates an exemplary block diagram of the apparatus for seawater reverse osmosis using the hollow fiber RO membrane and the nanofiltration unit, in accordance with an embodiment of the disclosure. FIG. 6 is explained in conjunction with FIGS. 1. 2,3,4 and 5. In FIG. 6 there is shown a block diagram 600 of the apparatus 102 for seawater reverse osmosis. The apparatus 102 may include the first stage treatment 302, the first stage purification 304, a second stage purification 408, the RO membrane unit 110, and the ion exchange unit 112. The first stage treatment 302 further includes a first mixing unit 106A and a second mixing unit 106B, a carbon dioxide unit 402, a chlorine dioxide unit 404, a ferric chloride unit 406. The first stage purification 304 includes the ultrafiltration unit 108. The second stage purification 408 includes the NF membrane unit 408A. The RO membrane unit 110 includes the hollow fiber RO membrane 110D.

In one embodiment, the apparatus 102 may control the one or more mixing units 106. The one or more mixings units 106 may include for example, the first mixing unit 106A and the second mixing unit 106B. The first mixing unit 106A may receive the liquid stream 104, the carbon dioxide and the chlorine dioxide. The apparatus 102 may control the first mixing unit 106A to add the carbon dioxide to the received liquid stream 104. Further, the apparatus 102 may control the first mixing unit 106A to add the chlorine dioxide to the received liquid stream 104. The processor 202 may be configured to control the first mixing unit 106A to pass the liquid stream 104 to the second mixing unit 106B. The details of the addition of the carbon dioxide (CO2) and the chlorine dioxide (ClO2) are provided in FIG. 3.

In an embodiment, the second mixing unit 106B may receive the liquid stream from the first mixing unit 106A. The apparatus 102 may control the second mixing unit 106B to add ferric chloride (FeCl3) to the liquid stream 104. The details of addition of the ferric chloride (FeCl3) are described in FIG. 3.

In another embodiment, the apparatus 102 may control the ultrafiltration unit 108 to perform the first stage purification 304. The ultrafiltration unit 108 may receive the first liquid stream 302B from the second mixing unit 106B. Further, the ultrafiltration unit 108 may remove the agglomerated first set of impurities from the first liquid stream 302B to obtain second liquid stream 304A. The details of ultrafiltration unit 108 and the first stage purification 304 are described in FIG. 1 and FIG. 3

In one embodiment, the apparatus 102 may further include the NF membrane unit 408A. The NF membrane unit 408A may be coupled with the ultrafiltration unit 108. The apparatus 102 may be configured to control the NF membrane unit 408A to perform a second stage purification 408 of the second liquid stream 304A to output at least one of a NF brine stream 408C, and a NF permeate stream 408B. Further, the apparatus 102 may be configured to transfer the NF permeate stream 408B to the RO membrane unit 110 to obtain the filtered liquid stream 114. The details of NF membrane unit 408A are provided in FIG. 4.

In an embodiment, the apparatus 102 may control the brine processing unit 410 to receive the NF brine stream 408C and extract a fourth set of chemical compounds. The brine processing unit 310 may process the NF brine stream 408C to recover resources such as extracting salts and minerals for reuse or commercial purposes. The details about the brine processing unit 410 are provided in FIG. 4.

In one embodiment, the apparatus 102 may further control the RO membrane unit 110 to receive the NF permeate stream 408B from the NF membrane unit 408A. The NF membrane unit may include the hollow fiber RO membrane 110D. The NF permeate stream 408B may be further pressurized and received by the RO membrane unit 110. The processor 202 may be further configured to control the RO membrane unit 110 to split the NF permeate stream into two further streams. The further two streams may be, but not limited to, the RO brine stream 110C and the RO permeate stream 110B. The details of the RO membrane unit are provided in FIG. 4. and the details of the hollow fiber RO membrane 110D are provided in FIG. 5.

In an exemplary embodiment, the RO permeate stream 110B may further spilt into two different streams. A first portion of the RO permeate stream 110B may pass through the ion exchange unit 112 to remove boron. The remaining portion of the RO permeate stream 110B may be untreated and blended with the boron deficient stream that may be coming out from the ion exchange unit 112, to form the filtered liquid stream 114.

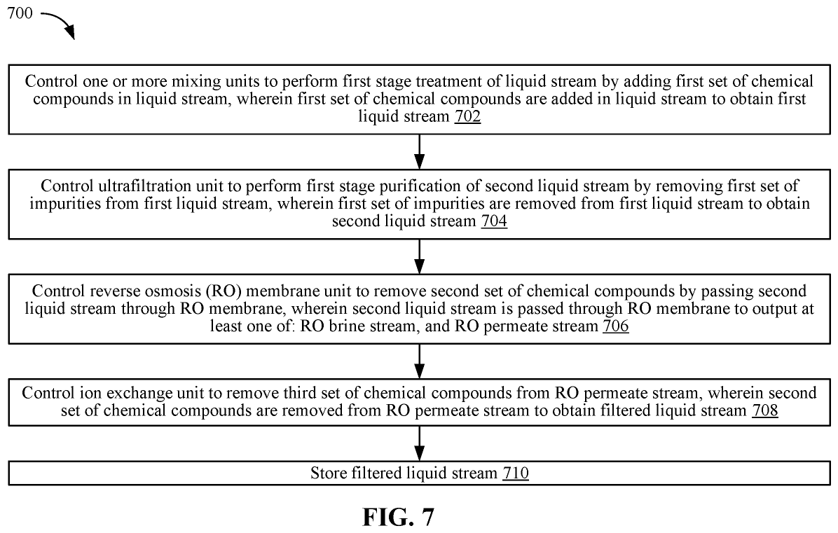

FIG. 7 is a flowchart that illustrates an exemplary method for seawater reverse osmosis, in accordance with an embodiment of the disclosure. FIG. 7 is explained in conjunction with elements from FIGS. 1, 2, 3, 4, 5 and 6. With reference to FIG. 7 there is shown a flowchart 700. The operations of the exemplary method may be executed by any computing system, for example, by the apparatus 102 of FIG. 1 or the processor 202 of FIG. 2. The operations of the flowchart 700 may start at 702.

At 702, the one or more mixing units 106 may be controlled to perform the first stage treatment 302 of the liquid stream 104 by adding the first set of chemical compounds 302A in the liquid stream 104. The first set of chemical compounds 302A may be added in the liquid stream to obtain the first liquid stream 302B. In an embodiment, the processor 202 may be configured to control the one or more mixing units 106 to perform the first stage treatment 302 of the liquid stream 104 by adding the first set of chemical compounds 302A in the liquid stream 104. The first set of chemical compounds 302A may be added in the liquid stream to obtain the first liquid stream 302B.

At 704, the ultrafiltration unit 108 may be controlled to perform a first stage purification 304 of the first liquid stream 302B by removing the first set of impurities from the first liquid stream 302B. The first set of impurities may be removed from the first liquid stream 302B to obtain a second liquid stream 304A. In an embodiment, the processor 202 may be configured to control the ultrafiltration unit 108 to perform a first stage purification 304 of the first liquid stream 302B by removing the first set of impurities from the first liquid stream 302B. The first set of impurities may be removed from the first liquid stream 302B to obtain a second liquid stream 304A.

At 706, the RO membrane unit 110 may be controlled to remove the second set of chemical compounds by passing the second liquid stream 304A through the RO membrane to output at least one of the RO brine stream 110C, and the RO permeate stream 110B. In an embodiment, the processor 202 may be configured to control the RO membrane unit 110 to remove the second set of chemical compounds by passing the second liquid stream 304A through the RO membrane to output at least one of the RO brine stream 110C, and the RO permeate stream 110B.

At 708, the ion exchange unit 112 may be controlled to remove the third set of chemical compounds from the RO permeate stream 110B. The third set of chemical compounds may be removed from the RO permeate stream 110B to obtain the filtered liquid stream 114. In an embodiment, the processor 202 may be configured to control the ion exchange unit 112 to remove the third set of chemical compounds from the RO permeate stream 110B. The third set of chemical compounds may be removed from the RO permeate stream 110B to obtain the filtered liquid stream 114.

At 710, the filtered liquid stream 114 may be stored. In an embodiment, the processor 202 may be configured to store the filtered liquid stream 114.

Alternatively, the apparatus 102 may include means for performing each of the operations described above. In this regard, according to an example embodiment, examples of means for performing operations may comprise, for example, the processor and/or a device or circuit for executing instructions or executing an algorithm for processing information as described above.

Various embodiments of the disclosure may provide a non-transitory computer readable medium having stored thereon computer executable instructions, which when executed by one or more processors (such as the processor 202), cause the one or more processors to carry out operations to operate an apparatus (e.g., the apparatus 102) for seawater reverse osmosis. The instructions may cause the machine and/or computer to perform operations including, controlling one or more mixing units 106 to perform a first stage treatment of liquid stream 104 by adding a first set of chemical compounds 302A to the liquid stream 104. The first set of chemical compounds 302A may be added in the liquid stream 104 to obtain a first liquid stream 302B. The operations may further include controlling the ultrafiltration unit 108 to perform a first stage purification of the first liquid stream 302B by removing a first set of impurities from the first liquid stream 302B. The first set of impurities are removed from the first liquid stream to obtain a second liquid stream 304A. The operations may further include controlling a nanofiltration membrane unit 408A to perform a second stage purification of the second liquid stream 304A by at least one of modifying a pressure value of the second liquid stream 304A, inhibiting divalent ions of the second liquid stream 304A, and permitting a monovalent rich stream to pass through the NF membrane unit 408A. The second liquid stream 304A is passed through the NF membrane unit 408A to output at least one of a NF brine stream 408C, and a NF permeate stream 408B. The operations may further include controlling a reverse osmosis (RO) membrane unit 110 to remove a second set of chemical compounds by passing the NF permeate stream 408B through a RO membrane to output at least one of a RO brine stream 110C, and a RO permeate stream 110B. The operations may further include controlling an ion exchange unit 112 to remove a third set of chemical compounds from the RO permeate stream 110B. The third set of chemical compounds are removed from the RO permeate stream 110B to obtain a filtered liquid stream 114. Further, the operations may include storing the filtered liquid stream.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed:

1. An apparatus, comprising:
one or more processors configured to:
control one or more mixing units to perform a first stage treatment of liquid stream by adding a first set of chemical compounds in the liquid stream, wherein the first set of chemical compounds are added in the liquid stream to obtain a first liquid stream;
control an ultrafiltration unit to perform a first stage purification of the first liquid stream by removing a first set of impurities from the first liquid stream, wherein the first set of impurities are removed from the first liquid stream to obtain a second liquid stream;
control a reverse osmosis (RO) membrane unit to remove a second set of chemical compounds by passing the second liquid stream through a RO membrane, wherein the second liquid stream is passed through the RO membrane to output at least one of: a RO brine stream, and a RO permeate stream;
control an ion exchange unit to remove a third set of chemical compounds from the RO permeate stream, wherein the third set of chemical compounds are removed from the RO permeate stream to obtain a filtered liquid stream; and
store the filtered liquid stream.

2. The apparatus of claim 1, wherein the first set of chemical compounds further comprises of at least one of: carbon dioxide (CO₂), chlorine dioxide (ClO₂) and ferric chloride (FeCl₃).

3. The apparatus of claim 1, wherein the first set of impurities further comprises of at least one of: suspended solids, colloidal particulates, or organic contaminants.

4. The apparatus of claim 1, wherein the second set of chemical compounds further comprises of at least one of: salts, minerals, cations, or anions.

5. The apparatus of claim 1, wherein the third set of chemical compounds further comprises of boron.

6. The apparatus of claim 1, wherein the one or more processors are further configured to:
control the one or more mixing units to modify a Potential of Hydrogen (pH) value based on the addition of the first set of chemical compounds, wherein a pH value of the first liquid stream is lesser than a pH value of the liquid stream;
control the one or more mixing units to remove a second set of impurities from the liquid stream based on the addition of the first set of chemical compounds; and
control the one or more mixing units to agglomerate the first set of impurities of the liquid stream based on the addition of the first set of chemical compounds.

7. The apparatus of claim 6, wherein the second set of impurities further comprises of at least one of: microorganisms, or biological contaminants.

8. The apparatus of claim 1, wherein the apparatus further comprises of a nanofiltration (NF) membrane unit, and wherein the one or more processors are further configured to:
control the NF membrane unit to perform a second stage purification of the second liquid stream to output at least one of: a NF brine stream, and a NF permeate stream; and
transfer the NF permeate stream to the RO membrane unit to obtain the filtered liquid stream.

9. The apparatus of claim 8, wherein the one or more processors are further configured to:
control the NF membrane unit to modify a pressure value of the second liquid stream to obtain the NF permeate stream, wherein a first pressure value of the second liquid stream is greater than a second pressure value of the NF permeate stream;
control the NF membrane unit to inhibit divalent ions of the second liquid stream to obtain the NF brine stream; and
control the NF membrane unit to permit the NF permeate stream to pass through the NF membrane unit, wherein the NF permeate stream corresponds to a monovalent rich stream.

10. The apparatus of claim 8, wherein the apparatus further comprises of a brine processing unit and wherein the one or more processors are further configured to control the brine processing unit to process the NF brine stream to extract a fourth set of chemical compounds.

11. The apparatus of claim 10, wherein the fourth set of chemical compounds further comprises of at least one of: magnesium, calcium, sulphate or bromate.

12. The apparatus of claim 1, wherein the RO membrane further comprises of at least one of: a spiral wound RO membrane, or a hollow fiber RO membrane.

13. A method, comprising:
controlling one or more mixing units to perform a first stage treatment of liquid stream by adding a first set of chemical compounds to the liquid stream, wherein the first set of chemical compounds are added in the liquid stream to obtain a first liquid stream;
controlling an ultrafiltration unit to perform a first stage purification of the first liquid stream by removing a first set of impurities from the first liquid stream, wherein the first set of impurities are removed from the first liquid stream to obtain a second liquid stream;
controlling a reverse osmosis (RO) membrane unit to remove a second set of chemical compounds by passing the second liquid stream through a RO membrane, wherein the second liquid stream is passed through the RO membrane to output at least one of: a RO brine stream, and a RO permeate stream;
controlling an ion exchange unit to remove a third set of chemical compounds from the RO permeate stream, wherein the third set of chemical compounds are removed from the RO permeate stream to obtain a filtered liquid stream; and
storing the filtered liquid stream.

14. The method of claim 13, wherein the first set of chemical compounds further comprises of at least one of: carbon dioxide (CO₂), chlorine dioxide (ClO₂) and ferric chloride (FeCl₃).

15. The method of claim 13, further comprising:
controlling the one or more mixing units to modify a Potential of Hydrogen (pH) value based on the addition of the first set of chemical compounds, wherein a pH value of the first liquid stream is lesser than a pH value of the liquid stream;
controlling the one or more mixing units to remove a second set of impurities from the liquid stream based on the addition of the first set of chemical compounds; and
controlling the one or more mixing units to agglomerate the first set of impurities of the liquid stream based on the addition of the first set of chemical compounds.

16. The method of claim 13, further comprising:
controlling a nanofiltration (NF) membrane unit to perform a second stage purification of the second liquid stream to output at least one of: a NF brine stream, and a NF permeate stream; and
transferring the NF permeate stream to the RO membrane unit to obtain the filtered liquid stream.

17. The method of claim 16, further comprising:
controlling the NF membrane unit to modify a pressure value of the second liquid stream to obtain the NF permeate stream, wherein a first pressure value of the second liquid stream is greater than a second pressure value of NF permeate stream;
controlling the NF membrane unit to inhibit divalent ions of the second liquid stream to obtain the NF brine stream; and
controlling the NF membrane unit to permit the NF permeate stream to pass through the NF membrane unit, wherein the NF permeate stream corresponds to a monovalent rich stream.

18. The method of claim 16, further comprising passing the NF brine stream, through a brine processing unit, to extract a fourth set of chemical compounds.

19. The method of claim 13, wherein the RO membrane further comprising at least one of: a spiral wound RO membrane, or a hollow fiber RO membrane.

20. A computer programmable product comprising a non-transitory computer readable medium having stored thereon computer executable instructions, which when executed by one or more processors, cause the one or more processors to carry out operations comprising:
controlling one or more mixing units to perform a first stage treatment of liquid stream by adding a first set of chemical compounds to the liquid stream, wherein the first set of chemical compounds are added in the liquid stream to obtain a first liquid stream;
controlling an ultrafiltration unit to perform a first stage purification of the first liquid stream by removing a first set of impurities from the first liquid stream, wherein the first set of impurities are removed from the first liquid stream to obtain a second liquid stream;
controlling a nanofiltration (NF) membrane unit to perform a second stage purification of the second liquid stream by at least one of: modifying a pressure value of the second liquid stream, inhibiting divalent ions of the second liquid stream, and permitting a monovalent rich stream to pass through the NF membrane unit, wherein the second liquid stream is passed through the NF membrane unit to output at least one of: a NF brine stream, and a NF permeate stream;
controlling a reverse osmosis (RO) membrane unit to remove a second set of chemical compounds by passing the NF permeate stream through a RO membrane, wherein the NF permeate stream is passed through the RO membrane to output at least one of: a RO brine stream, and a RO permeate stream;
controlling an ion exchange unit to remove a third set of chemical compounds from the RO permeate stream, wherein the third set of chemical compounds are removed from the RO permeate stream to obtain a filtered liquid stream; and
storing the filtered liquid stream.
